(19) United States
(12) Patent Application Publication
(10) Pub. No.: US 2010/0085279 A1
(43) Pub. Date: Apr. 8, 2010

(54) INTERACTIVE DISPLAY BRACELET

(76) Inventor: Sean R. Repko, Valley Center, CA (US)

Correspondence Address: NYDEGGER & ASSOCIATES, 348 OLIVE STREET, SAN DIEGO, CA, 92103, US

(21) Appl. No.: 12/244,126

(22) Filed: Oct. 2, 2008

(51) Int. Cl. G09G 3/30

(52) U.S. Cl. 345/76; 40/633

(57) ABSTRACT

A bracelet worn by a user displays images, including direct advertisements, received from a remote device. Structurally, the bracelet forms a circumference about a void for receiving the user's wrist. Further, the bracelet includes a wireless communication receiver for receiving signals from the remote device. Also, the bracelet includes a display element positioned along the circumference for displaying images defined by the signals. Typically, the display element will comprise light-emitting diodes (LEDs), organic light-emitting diodes (OLEDs), liquid crystal display (LCD) panels, and/or fiber optics.

### FIELD OF THE INVENTION

The present invention pertains to fashion accessories such as bracelets. More specifically, the present invention pertains to bracelets which are designed to display images acquired from a remote device through wireless communication. The present invention is particularly, but not exclusively, useful as an interactive display bracelet for presenting images, including direct advertisements, to a user.

### BACKGROUND OF THE INVENTION

As electronic devices become more prevalent, additional avenues of communication have opened. For instance, email has provided a completely new medium for advertising. Because cellular phones are carried with users virtually all of the time, they provide an even greater opportunity for advertising. Increasingly, cellular phones are replacing the need for multiple electronic devices. Specifically, cellular phones now perform the functions of cameras, video cameras, calculators, web browsers, personal digital assistants, and alarm clocks, among others. Typically, cellular phones are of three designs—smartphones, flip top phones, and candybar phones. Each of these designs provides a planar screen for displaying images to a user. As a result, the viewing angle of the phone screen is quite limited.

While cellular phones are continually manufactured in slimmer and narrower designs, they nevertheless require the users to carry and hold the phones. Further, due to the copious amounts of personal information stored on cellular phones, they are protected from communication with unknown sources. Specifically, cellular phones do not typically provide for the receipt of unrequested wireless information from local networks. Further, cellular phones generally do not allow for communication to a phone owner based on location. In fact, cellular phones typically display information from a third party to a user only when directly and purposely contacted by that third party through the cellular phone's dedicated contact number.

In light of the foregoing, the present invention recognizes the need for a device that is able to display images, including text, received over local open networks. Further, the present invention recognizes the need for such a device that provides a greater than 180 degree viewing angle of the images and that can be seen by others in the area. It is therefore an object of the present invention to provide an interactive display bracelet for receiving wireless communication from remote devices. It is a further object of the present invention to provide an interactive bracelet that displays images, including text, defined by the communication. It is another object of the present invention to provide a bracelet for displaying images which includes a data input element for receiving local instruction from the user. It is yet a further object of the present invention to provide an interactive display bracelet that includes a sensor and an image rectifier to present the images in an upright orientation regardless of the bracelet orientation. Still another object of the present invention is to provide an interactive display bracelet having a display screen or array hidden among the aesthetic design of the bracelet. Another object of the present invention is to provide an interactive display bracelet which is easy to install and use, relatively easy to manufacture, and comparatively cost-effective.

### SUMMARY OF THE INVENTION

In accordance with the present invention, an interactive display bracelet is provided for communicating images, including text, received wirelessly from an authorized remote device. Importantly, the images may comprise personal text messages, push-text messages, or other communications. For instance, a bracelet wearer may be in a restaurant that provides advertisements or specials through push-text messages. Specifically, the restaurant's computer system or local network may communicate a universal signal carrying a push-text message that is receivable by patrons wearing the display bracelet. In this manner, the restaurant encourages use of the bracelet and can maximize use of its specials sales. At this same time, the bracelet may be used to receive personal messages.

Structurally, the bracelet is formed by a housing structure that replicates a typical non-functional bracelet. Specifically, the bracelet may comprise a single solid band or may include a latch or hinge as desired. In either case, the housing structure defines a generally cylindrical circumference that bounds a void for receiving the user's wrist. Further, the structure has an inside surface worn against the wrist, and an outside surface.

For wireless communication, the bracelet includes a receiver that is mounted within the housing structure. Functionally, the receiver is able to receive wireless communication such as through Bluetooth technology or through infrared communication. Specifically, the receiver acquires signals from remote devices such as cellular phones, computers, and networks. In order to interpret the signals, the receiver is electronically connected to a circuit board.

Further, the bracelet includes a display means that is comprised of elements such as light-emitting diodes (LEDs), organic light-emitting diodes (OLEDs), liquid crystal display (LCD) panels, and/or fiber optics. Through use of these elements, the display means is able to emit images in a fixed or scrolling manner. In certain embodiments, the display means may show visual images such as photos, or streaming video. Structurally, the display means extends about 180 degrees around the circumference of the bracelet. As a result, the bracelet provides the same viewing angle for the user. Also, the images emitted by the display means may be strobing. Specifically, flashing LEDs may be used to scan a message into the air as the wearer waves his arm.

In certain embodiments, the circuit board includes a sensor, such as a gyrometer, in order to determine the orientation of the bracelet as it is worn. In connection with the orientation sensor, the circuit board includes an image rectifier. As a result, the circuit board instructs the display means to show the image in a desired “upright” orientation in order to facilitate viewing.

For operation, the bracelet is provided with a battery that provides power to all of the bracelet's electronic components. Further, the bracelet includes data entry means such as buttons for activating and deactivating the bracelet, for ignoring messages, for adjusting the display brightness, and for similar purposes.

Importantly, the display means and other electronic components are blended in with the aesthetic nature of the bracelet. Further, the bracelet may include jewels that are integrated with the display means. Specifically, fiber optics may be used to selectively illuminate jewels to provide an alert, text message, or for non-functional purposes. For instance, an array of jewels can be selectively illuminated to form text. Also, the bracelet may include a vibrator and an enunciator to provide tangible or audio alerts in response to received signals.

During use, the display means is easily viewed by others in the vicinity of the bracelet wearer. As a result, the bracelet may be used as a viral marketing device. Specifically, after seeing images displayed by the bracelet, others may want a bracelet, or act on the message communicated by the bracelet.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic view of the wireless connection between the interactive display bracelet and a remote device in accordance with the present invention;

FIG. 2A is a perspective view of the interactive display bracelet of FIG. 1 in accordance with the present invention;

FIG. 2B is a perspective view of the bracelet of FIG. 2A, illustrating the display of images in an upright orientation;

FIG. 3 is a cross sectional view of the bracelet taken along line 3-3 in FIG. 2B;

FIG. 4 is a cross sectional view of a bracelet in accordance with the present invention, with the image displaying means illustrated;

FIG. 5 is a cross sectional view of a bracelet in accordance with the present invention, including jewels connected to the displaying means for illumination; and

FIG. 6 is a flow chart illustrating the operation of the interactive display bracelet in accordance with the present invention.

### DESCRIPTION OF THE PREFERRED EMBODIMENTS

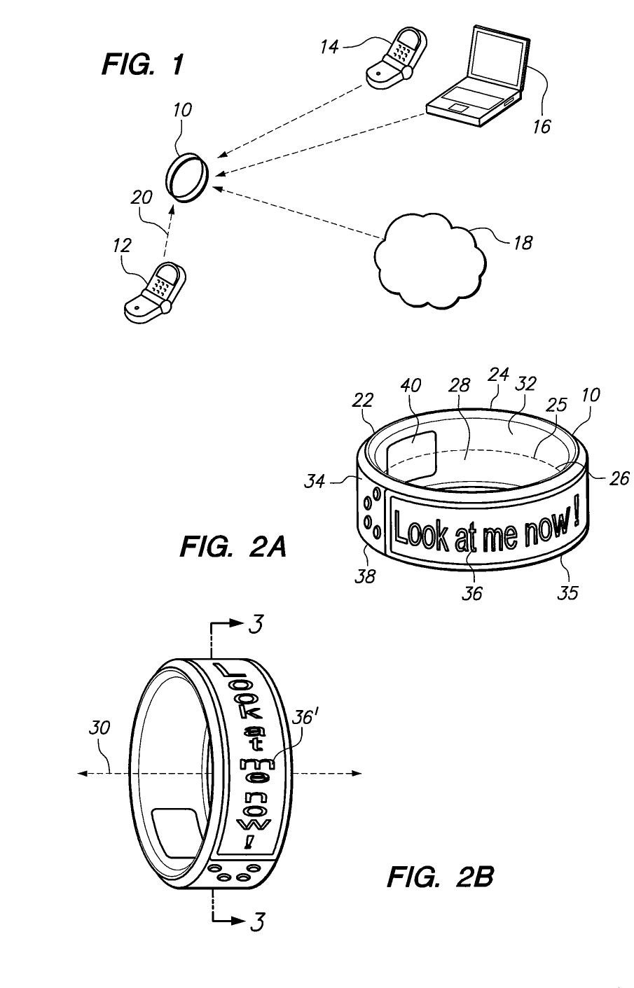

Referring initially to FIG. 1, an interactive display bracelet is shown and designated 10. In the present invention, the bracelet 10 is adapted for wireless communication with a remote device, such as the user's cellular phone 12. Also, the bracelet 10 is adapted to receive data through wireless communication with other remote devices, such as a third party's cellular phone 14, a computer 16, or a local network or Internet 18. In each case, the bracelet 10 receives signals 20 from the respective remote device 12, 14, 16, 18 through a wireless transmission.

As shown in FIGS. 2A and 2B, the bracelet 10 includes a housing structure 22 which forms a generally cylindrical circumference 24. Further, the structure 22 can be considered to include a circular midline 25 that defines a plane 26. As Also, the circumference 24 bounds a void 28 and is centered about an axis 30 perpendicular to the plane 26. As shown, the structure 22 includes an inside surface 32 and an outside surface 34.

On the outside surface 34 of the structure 22, the bracelet 10 includes a display means 35. For the present invention, the display means 35 is capable of presenting images 36 in a fixed format, in scrolling format, or in motion strobing format. Importantly, the bracelet 10 is equipped to determine the orientation of the bracelet 10 and to rectify the image 36 so that the image is upright. This can be seen when cross-referencing the image 36 in FIG. 2A with the image 36′ in FIG. 2B. As shown in FIG. 2A, the present invention further provides buttons 38 or other data input means on the structure 22 for operation of the bracelet 10. Also, a battery 40 or other power source is shown mounted in the structure 22 to provide power for operation of the interactive display bracelet 10.

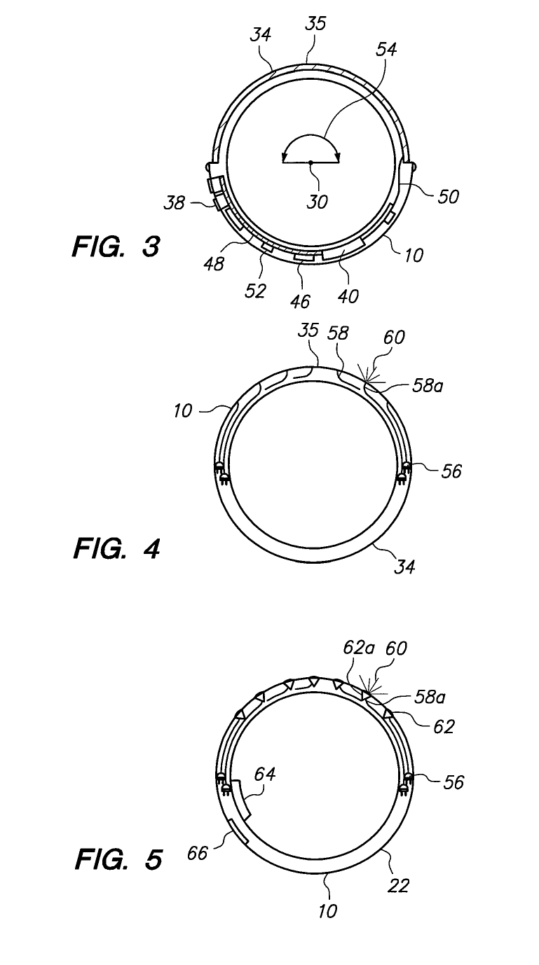

Referring now to FIG. 3, it can be seen that the bracelet 10 includes a wireless communication transmitter/receiver 46 for accepting the signals 20 from authorized remote devices 12, 14, 16, 18. For the bracelet 10, authorization may occur in one of two ways. First, the receiver 46 may be initially programmed to accept signals from a selected remote device 12, 14, 16, 18. For instance, a restaurant or bar may sell bracelets 10 that are set up to receive signals 20 communicating promotions, specials or advertisements from the establishment's computer 16 or network 18. Alternatively or additionally, the user may authorize the receipt of signals 20 as they arrive from other remote devices 12, 14, 16, 18. For transmission, the transmitter/receiver 46 allows simple communication between the bracelet 10 and a remote device 12, 14, 16, 18. As a result, the identity and/or location of the bracelet 10 can be communicated to the remote device 12, 14, 16, 18. Further, the simple communication capability allows the bracelet 10 to indicate what messages the wearer would like to receive, or any promotions they have acted on.

As shown, the receiver 46 is connected to an electronic circuit board 48 for interpreting the signals 20. Further, the circuit board 48 is connected to the data input means 38 to allow the user to provide instructions to the bracelet 10. Also, the circuit board 48 is connected to the battery 40. Importantly, the circuit board 48 is connected to the display means 35 through cables 50. Also connected to the circuit board 48 is an orientation sensor 52, such as a gyrometer, for determining the orientation of the bracelet 10. In response to changes in the orientation of the bracelet 10, the circuit board 48 determines whether to display the image 36 “laterally” as in FIG. 2A or “vertically” like the image 36′ in FIG. 2B.

As shown in FIG. 3, the display means 35 extends along the cylindrical outside surface 34 about the axis 30 for a viewing angle 54 of about 180 degrees. In FIG. 3, the display means 35 is shown as being cylindrical. Alternatively, it is envisioned that a series of planar panels abutting one another at slight angles could be used. Specifically, the series of panels could replicate the cylindrical nature of the illustrated display means 35 while providing the same viewing angle 54. Such an embodiment could be used with planar elements such as liquid crystal display panels. Further, the display means 35 can be comprised of light-emitting diodes (LEDs), organic light-emitting diodes (OLEDs), liquid crystal, and/or fiber optics.

Referring now to FIG. 4, the components of the display means 35 are shown in detail. As can be seen, the bracelet 10 includes diodes 56 which are electronically connected to the circuit board 48 via cable 50 (shown in FIG. 3). Further, the diodes 56 are connected to fiber optics 58 that form the display means 35. As shown in FIG. 4, light 60 is being emitted from the fiber optic 58a to form an image 36. In this manner, the circuit board 48 may control what images 36 are shown by the display means 35.

Referring now to FIG. 5, it can be seen that the bracelet 10 may include natural or synthetic jewels 62 that are embedded in the outside surface 34 of the bracelet structure 22. As shown, the jewel 62a is connected to a diode 56 via a fiber optic line 58a. As a result, light 60 may be emitted through the fiber optic line 58a to illuminate the jewel 62a. In view of the connection between the circuit board 48 and the diodes 56, it may be understood that creation of the image 36 on the display means 35, and illumination of selected jewels 62 is coordinated. Alternatively, LEDs can be positioned directly underneath jewels 62 to provide for selective illumination without fiber optics 58. In any case, illumination of selected jewels 62 may be used to provide a predetermined indication from the remote device 12, 14, 16, 18.

Also, as shown in FIG. 5, the bracelet 10 may include a vibrator 64 that is in electronic communication with the circuit board 48. As a result, the vibrator 64 may provide a tangible alert to a user in response to a signal 20. Further, the bracelet 10 may include an audio enunciator 66 for providing an audible alert to a user in response to a signal 20.

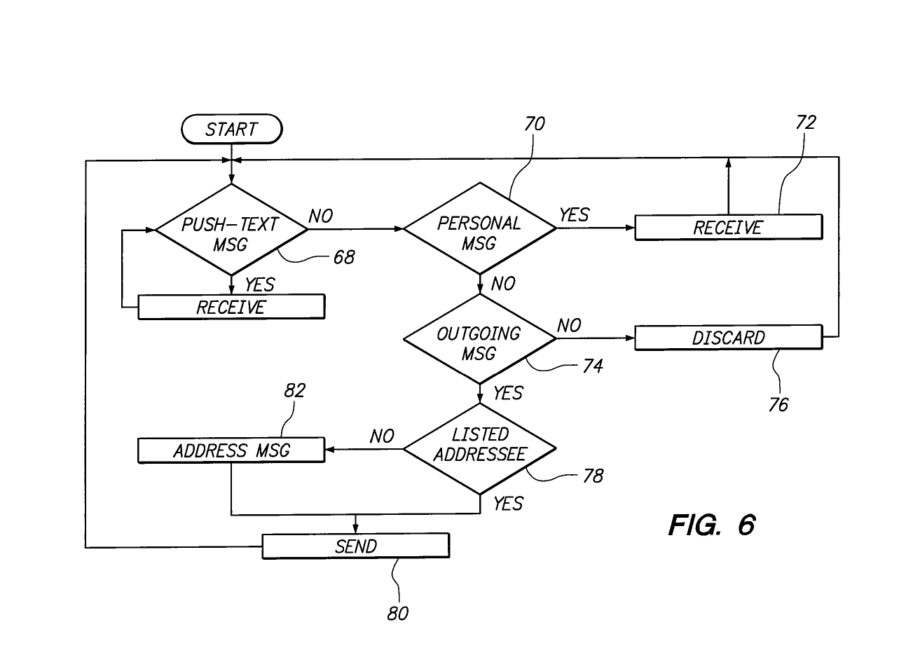

Referring now to FIG. 6, the operation of the bracelet 10 upon receipt of a signal 20 is shown. At inquiry block 68, the signal 20 is analyzed to determine whether it is a push-text message. Specifically, during this determination the circuit board 48 may identify the sender of the signal 20, or the signal 20 may include an indication that it is a push-text message. If it is determined to be a push-text message, the signal 20 is communicated by the circuit board 48 to the display means 35 and the message is shown by the bracelet 10. For instance, the push-text message may be an advertisement offer distributed from a local network 18 in a retail establishment. At that time, the user may indicate acceptance of the offer through the data entry means 38.

If the signal 20 does not represent a push text message, then it is determined whether the signal 20 represents a personal message at inquiry block 70. Specifically, the circuit board 48 may recognize the sender of the message as a known contact, or the circuit board 48 may determine that the sender is a personal cellular phone 14. In any case, if it is determined that the signal 20 represents a personal message, the message is received at action block 72 and the circuit board 48 prompts the display means 35 to show the message.

If it is determined that the signal 20 does not represent a personal message, then the circuit board 48 determines whether the signal 20 represents an outgoing message from the user's cellular phone 12 (inquiry block 74). If the signal 20 is not an outgoing message, then the signal 20 is discarded at action block 76. If the circuit board 48 determines that the signal 20 is an outgoing message, then the identity of the addressee is queried at inquiry block 78. If the address is known, then the message is sent at action block 80. If the addressee is unknown, then the addressee is confirmed or re-entered at action block 82. Thereafter, the message is sent at action block 80.

While the particular Interactive Display Bracelet as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as defined in the appended claims.

What is claimed is:

1. A bracelet worn by a user for displaying images from remote devices comprising:
a bracelet structure forming a circumference about a void for receiving the user's wrist, said bracelet structure having an inside surface worn against the user's wrist and an outside surface;
a wireless communication receiver mounted in the structure for receiving signals from the remote devices, wherein the receiver is programmed to accept the signals from authorized remote devices, and wherein the signals define images; and
a means for displaying the images defined by the signals, said displaying means being positioned along the circumference on the outside surface of the bracelet structure.

2. A bracelet as recited in claim 1 wherein the displaying means comprises elements selected from the group consisting of light-emitting diodes (LEDs), organic light-emitting diodes (OLEDs), liquid crystal display (LCD) panels, and fiber optics.

3. A bracelet as recited in claim 1 further comprising at least one jewel positioned on the outside surface of the bracelet structure, wherein the displaying means is connected to the jewel to selectively illuminate the jewel.

4. A bracelet as recited in claim 1 wherein the bracelet structure defines a plane, wherein the circumference is centered about an axis perpendicular to the plane, wherein the displaying means projects light radially outward from the outside surface of the bracelet structure to form the images, and wherein the images are visible in the plane from greater than 180 degrees about the axis.

5. A bracelet as recited in claim 1 wherein the images scroll around the circumference of the bracelet structure.

6. A bracelet as recited in claim 1 further comprising an orientation sensor for determining the orientation of the bracelet, and an image rectifier for orienting the image in an upright configuration.

7. A bracelet as recited in claim 1 further comprising data input means for controlling the bracelet.

8. A bracelet as recited in claim 1 wherein the bracelet structure is flexible.

9. A bracelet as recited in claim 1 further comprising a battery connected to the receiver and displaying means for powering operation of the bracelet.

10. A bracelet as recited in claim 1 wherein the remote devices are selected from the group consisting of a cell phone, a computer, and a network.

11. An article for providing advertisements from an authorized remote device to a user comprising:
a structure having an outside surface forming a circumference about an axis, wherein the circumference defines a plane perpendicular to the axis;
a wireless communication receiver mounted in the structure for receiving signals from the authorized remote device, wherein the signals define images conveying the advertisement;
a means for displaying the images defined by the signals, said displaying means being positioned along the circumference on the outside surface of the structure to project light radially outward to form the images, wherein the images are visible in the plane from greater than 180 degrees about the axis; and
a means for indicating acceptance of terms included in the advertisement.

12. An article as recited in claim 11 wherein the displaying means comprises elements selected from the group consisting of light-emitting diodes (LEDs), organic light-emitting diodes (OLEDs), liquid crystal display (LCD) panels, and fiber optics.

13. An article as recited in claim 11 wherein the images scroll around the circumference of the structure.

14. An article as recited in claim 11 further comprising an orientation sensor for determining the orientation of the article, and an image rectifier for orienting the image in an upright configuration.

15. An article as recited in claim 11 further comprising a battery connected to the receiver and displaying means for powering operation of the displaying means.

16. An article as recited in claim 11 wherein the remote device is selected from the group consisting of a cell phone, a computer, and a network.

17. A method of advertising through two-way communication between a remote device and a wearable display article comprising the steps of:
positioning the display article on a user, wherein the article has a structure with a wireless communication receiver mounted therein, and wherein the structure defines an outside surface with a displaying means positioned thereon;
authorizing the receiver to accept signals from the remote device;
transmitting a signal from the remote device to the receiver, wherein the signal comprises an advertisement defined by images;
displaying the images on the display means in response to the signal; and
communicating a response from the display article to the remote device in response to the signal.

18. A method as recited in claim 17 wherein the article is a bracelet, wherein the structure forms a circumference about a void for receiving the user's wrist, wherein the structure has an inside surface worn against the user's wrist opposite the outside surface, and wherein the displaying means is positioned along the circumference on the outside surface of the bracelet structure.

19. A method as recited in claim 18 wherein the article further comprises a data entry means, and wherein said authorizing step includes the steps of:
identifying the remote device that transmitted the signals to the receiver;
prompting the user to accept or deny display of the images; and
displaying the images in response to an accept entry from the user.

20. A method as recited in claim 19 wherein the response indicates acceptance of terms of the advertisement.
